(19) United States
(12) Patent Application Publication
(10) Pub. No.: US 2019/0039400 A1
(43) Pub. Date: Feb. 7, 2019

(54) SECURITY DEVICES

(71) Applicant: DE LA RUE INTERNATIONAL LIMITED, Basingstoke, Hampshire (GB)

(72) Inventor: Lawrence COMMANDER, Reading (GB)

(73) Assignee: De La Rue International Limited, Basingstoke, Hampshire (GB)

(21) Appl. No.: 16/075,839

(22) PCT Filed: Jan. 26, 2017
(86) PCT No.: PCT/GB2017/050199

§ 371 Date: Aug. 6, 2018

(30) Foreign Application Priority Data
Feb. 8, 2016 (GB) 1602209.7

(51) Int. Cl. B42D 25/21; B42D 25/405; B42D 25/342; B42D 25/351; B42D 25/355; B42D 25/36; B42D 25/45

(52) U.S. Cl. CPC B42D 25/21; B42D 25/405; B42D 25/342; B42D 25/24; B42D 25/355; B42D 25/36; B42D 25/45; B42D 25/351

(57) ABSTRACT

A security device is disclosed having public recognition features for use with security substrates to make security documents. The security device has a partial opaque layer having light transmissive regions surrounded by one or more opaque regions. The transmissive regions define negative indicia which are visible when viewed in transmission but not in reflection. Security features are provided on opposing sides of the partial opaque layer forming sides of the security device. At least one of the security features has indicia which are visible when viewed in reflection from one of the sides and at least partially overlap with the negative indicia. The security device has a low optical density layer which is semitransparent in the visual spectral region and is provided within the transmissive regions. The low optical density layer has a substantially continuous layer of a semitransparent material or a screen of opaque screen elements.

### CROSS REFERENCE TO RELATED APPLICATIONS

This application is a 35 U.S.C. § 371 national stage entry of PCT Application PCT/GB2017/050199, filed on Jan. 26, 2017, which in turn claims the benefit under 35 U.S.C. § 119(a) of United Kingdom Application No. GB1602209.7, filed Feb. 8, 2016, the entire contents of each are incorporated by reference herein in their entirety.

### BACKGROUND

### 1. Field

The present disclosure relates to improvements in security devices for use in or on security substrates which are used to make security documents. In particular the disclosure is concerned with security devices having multiple public recognition features.

### 2. Description of Related Art

It is widely known to use security devices (also known as security elements) in banknotes, passports, certificates and other security documents. These security devices can be in a variety of forms, such as security threads, patches or strips, and may be partially or wholly embedded in a paper or plastic substrate or applied to the surface of the substrate. The security devices can have one or more security features, which generally provide different appearances depending on the viewing conditions, for example whether the security document is viewed in transmitted or reflected light or at an angle or under certain types of light etc.

EP-A-319157, for example, describes a security device made from a transparent plastic film provided with a continuous reflective metal layer, such as aluminium, which has been vacuumed deposited on the film. The metal layer is partially demetallised to provide clear demetallised regions that form indicia. When wholly embedded within a paper substrate, the security device is barely visible in reflected light. However, when viewed in transmitted light the indicia can be clearly seen highlighted against the dark background of the metallised area of the security device and adjacent areas of the paper. Such elements can also be used in a security document provided with repeating windows in at least one surface of the paper substrate in which the security device is exposed. A security document of this type, when viewed in transmitted light, will be seen as a dark line with the indicia highlighted. When viewed in reflected light on the windowed side, the bright shiny aluminium portions are readily visible in the windows. This type of security device has been highly successful within the market place and is supplied under the trade mark Cleartext®.

For a number of years banknote issuing authorities have had an interest in combining both the public recognition properties of Cleartext® with the covert and/or overt properties of other security features, in particular a machine-readable feature, such as a magnetic feature. To this end it is preferable to utilise machine-readable features that can be read using detectors already available to the banknote issuing authorities. Examples of such machine-readable devices are described in WO-A-92/11142 and EP-A-773872.

WO-A-2009/053673 describes a security device which combines Cleartext® with another security feature, one embodiment of which is a magnetic security feature. A Cleartext® security feature is first produced by a known a demetallisation technique and comprises a plastic carrier substrate and a metal layer with metal free areas defining a first set of indicia. A partial light scattering layer, which may be of a magnetic material, defines another set of indicia, and is applied so that it at least partially overlaps the metal free areas on one side of the security device. When the security device is viewed in transmission it has substantially the same appearance to that of the prior art Cleartext® security device, i.e. the negative text is highly visible. When the security device is viewed in reflected light from the side of the partial light scattering layer, however, the second set of indicia is visible. When the security device is viewed in reflected light from the opposing side, it also has substantially the same appearance to that of the prior art Cleartext® security device, i.e. shiny metal. Thus the security device has (at least) two different sets of indicia viewable in reflection from opposite sides of the substrate and, if a magnetic material is used, the magnetic layer also provides a machine readable feature.

It is also advantageous, in combatting counterfeiting, to combine a Cleartext® security feature with other types of optical security feature, such as lenticular devices, moiré interference devices, moiré magnification devices, colourshift layers, holograms and thin film interference structures. The optical security feature may comprise an array of focussing elements, preferably lenses or mirrors, configured for viewing of the pattern there through.

A moiré magnification type device may include a pattern which comprises an array of substantially identical micro images. The pitches of the array of focusing elements and the array of micro images and their relative locations are such that the array of focusing elements cooperates with the array of micro images to generate magnified version of the micro images due to the moiré effect. Examples of moiré magnification devices and effects that can be achieved are described in EP-A-0698256 and WO-A-2005106601.

A lenticular type device may include a pattern formed from an array of image elements, each image element representing a portion of an image. Image elements from at least two different images are interleaved across the array whereby a different one of the at least two different images is directed to the viewer by the array of focusing elements depending on the viewing angle. Some examples of lenticular devices are described in U.S. Pat. No. 4,892,336, WO-A-2011/051669, WO-A-2011051670, WO-A-2012/027779 and U.S. Pat. No. 6,856,462. More recently, two-dimensional lenticular devices have also been developed and examples of these are disclosed in British patent application numbers 1313362.4 and 1313363.2.

WO-A-2011/051668 describes one example of a lenticular type security device which has a lenticular device comprising an array of lenticular focusing elements located over a corresponding array of pairs of image strips. The image strips may be printed or formed from relief structures. One of each pair of image strips has portions defining a first image in a first colour and a second image in a second colour respectively. The other of each pair of image strips has portions defining the first image in the second colour and the second image in the first colour respectively. In a first viewing direction, a first image strip from each pair is visible through the respective lenticular focusing elements and, in a second viewing direction, a second image strip from each pair is visible through the respective lenticular focusing elements. When the device is tilted, a colour switch is observed between the first and second images.

This document also describes a combination of the lenticular device with a Cleartext® security feature. This form of security device has regions comprising complementary lenticular switching devices and regions comprising demetallised indicia. A metallised layer has been applied over the layer comprising image forming relief structures between a lenslet array. The metal layer provides two benefits. Firstly it improves the brightness and contrast of image elements formed by the relief structures. Secondly it allows the creation of demetallised indicia which can be viewed in reflective and in transmitted light.

It is also recognised that, the greater the number of different security features combined in a single security document, the harder it is for a counterfeiter to produce a counterfeit product. Security features can be combined to provide different visual effects (or sets of effects) when different sides of the security document are viewed in reflection and/or transmission or under other viewing conditions. Whilst multiple independent security features may be provided in or on the substrate used to form the security document, it may also be advantageous to combine different security features in a single security device. However that can lead to interference between, or a diminishment of, the effects of the different security features. In some instances, the security features can be separated by an opaque layer, which does not allow the security feature on one side of the security device to be visible from the other side. However, this solution cannot be employed where a negative indicia security feature, such as Cleartext®, is present as this requires the transmission of light for verification purposes.

### BRIEF SUMMARY OF THE DISCLOSURE

The present disclosure therefore provides a solution to this problem to enable two security features to be combined with a negative indicia security feature in a single security device.

The disclosure therefore provides a security device comprising:
a partial opaque layer comprising a plurality of light transmissive regions surrounded by one or more opaque regions, said light transmissive regions defining negative indicia which are visible when the security device is viewed in transmission but not in reflection, said negative indicia having a minimum dimension of 200 μm;
a first security feature on one side of the partial opaque layer forming a first side of the security device; and
a second security feature on an opposing side of the partial opaque layer forming a second side of the security device;
wherein at least one of the first and second security features comprises indicia which are visible when the security device is viewed in reflection from one of the first or the second side of the security device and at least partially overlap with the negative indicia; and
a low optical density layer which is semitransparent in the visual spectral region is provided within the light transmissive regions, said low optical density layer comprising a substantially continuous layer of a semitransparent material or a screen formed of opaque screen elements.

The first security feature is preferably an optically variable security feature, such as a colourshift feature, an array of focussing elements, a lenticular device, moiré interference device or moiré magnification device.

When the first side of the security device is viewed in reflection, said indicia preferably comprise at least two different images which are apparent at at least two respective angles of view.

The second security feature is preferably a light scattering security feature defining said indicia which are visible when the second side of the security device is viewed in reflection.

In a preferred embodiment of the disclosure the first and second security devices each have indicia which are visible when the security device is viewed in reflection from the first and the second side of the security device respectively and which each at least partially overlap with the negative indicia.

The partial opaque layer may be a partially demetallised film, the opaque regions being regions of metal.

The total optical density of the security device in the light transmissive regions is preferably in the range 0.4-1.2, and more preferably in the range 0.6-1.0.

Preferably the negative indicia have a minimum dimension of 300 μm.

The low optical density layer preferably comprises a screen formed of opaque screen elements, which cover 15 to 50% of the area of the transmissive regions, and more preferably 20 to 40%.

The screen elements are preferably specularly reflective and may be formed from metal or a metallic ink.

Preferably the low optical density layer has an optical density in the range of 0.05-0.7, preferably in the range of 0.05-0.3, and more preferably in the range of 0.05-0.2.

The semi-transparent material may be metal or metallic ink.

The disclosure further provides a security substrate comprising a base substrate and a security device as described above at least partially embedded in the base substrate, or applied thereto.

The disclosure further provides a security document formed from the aforementioned security substrate, preferably comprising a banknote, voucher, fiscal stamp, authentication label, passport, cheque, certificate or identity card.

### BRIEF DESCRIPTION OF THE DRAWINGS

Preferred embodiments of the present disclosure will now be described, by way of example only, with reference to the accompanying drawings, in which:

FIG. 1 is cross sectional end elevation of one embodiment of a security device according to the disclosure;

FIG. 2 is a plan view of the image layer of the lenticular security feature of the security device of FIG. 1;

FIGS. 3a and 3b are front elevations of the lenses and a simplified image layer of the lenticular security feature of the security device of FIG. 1;

FIGS. 3c and 3d show images A, B when the lenticular security feature of FIGS. 3a and 3b are viewed at different angles

FIG. 4 illustrates the appearance of the lenticular security feature of FIGS. 3a and 3b when viewed at different tilt angles;

FIG. 5 illustrates a detail of the structure of the FIG. 4 in enlarged form;

FIG. 6 is a plan view of the partially demetallised layer of the security device of FIG. 1;

FIG. 7 is a plan view of the partial magnetic layer of the security device of FIG. 1; and

FIG. 8 is a plan view of the partial magnetic layer of FIG. 7 superimposed on the partially demetallised layer of FIG. 6.

### DETAILED DESCRIPTION

The security device of the present disclosure comprises first and second security features 11,12 located on either side of a negative indicia security feature 13. The negative security feature may be of the type, for example, as described in EP-A-319157. The security features 11,12 must be of a type which allows the security device 10 as a whole to transmit sufficient light to enable the indicia of the negative indicia security feature 13 to be clearly visualised in transmissive light. The preferred optical density of such a security device 10 in the region of the negative indicia (which may comprise a masking layer overlying the indicia) to enable this to occur is 0.20 to 0.30. To enhance the security of the security device 10, at least one of the security features 12,13 has indicia which are visible in reflective light.

For the purpose of the present disclosure, optical density is measured on a transmission densitometer, with an aperture area equivalent to that of a circle with a 1 mm diameter, is preferably less than 0.3, more preferably less than 0.2 and even more preferably less than 0.1. A suitable transmission densitometer is the MacBeth TD932.

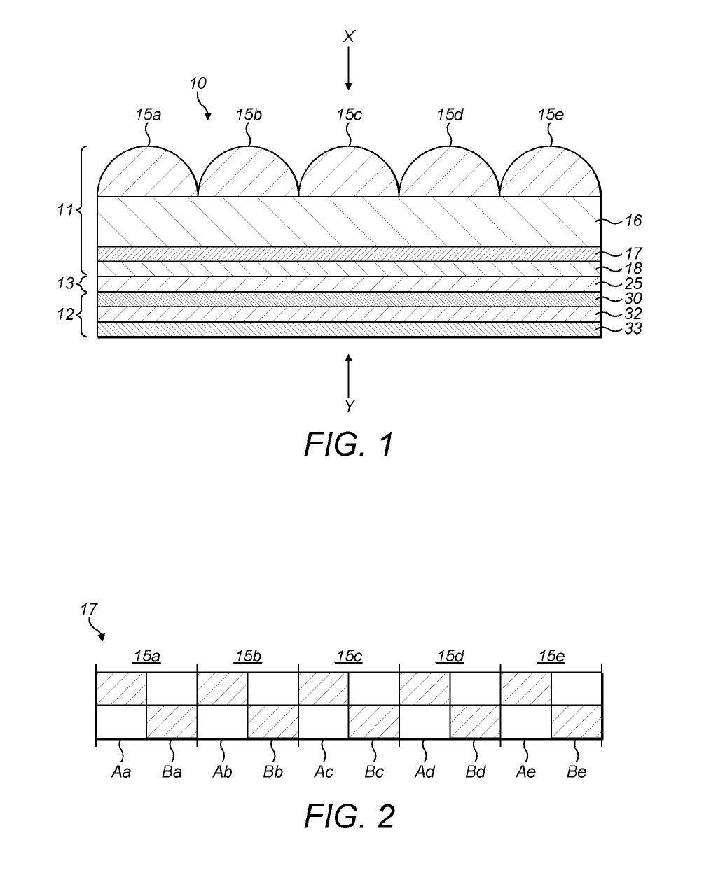

In one embodiment of the present disclosure, as shown in FIG. 1, the first security feature 11 comprises a lenticular security feature, such as that described in WO-A-2011/051668, which forms a first side of the security device 10. The second security feature 12 has a light scattering layer (which may be a magnetic layer), such as that described in WO-A-2009/053673, which forms an opposing second side of the security device 10. The negative indicia security feature 13 is located between the first security feature 11 and the second security feature 12. The contents of each of the aforementioned documents are incorporated herein by reference and alternative constructions and features of each security feature 11, 12, 13 as described in those documents may be employed in the present disclosure.

The first security feature 11 preferably comprises a parallel array of cylindrical lenses 15 (numbered as 15a, 15b, 15c, 15d, 15e in FIG. 1) arranged on a first side of a substantially transparent carrier layer 16. Although five lenses 15a, 15b, 15c, 15d, 15e are illustrated, there can be any suitable number of lenses 15. The array of lenses 15 may be located with their axes extending along a length, across a width of the security device 10 or at an angle to the length or width. The security device 10 may have a plurality of first security features 11, which may be located immediately adjacent to or separated from each other. Where there is a plurality of first security features 11, the axes of the lenses 15 of the different first security features 11 may extend in different directions.

The carrier layer 16 is preferably formed from a polymeric material such as polyethylene terephthalate (PET) or polypropylene.

The preferred thickness of the security device 10 is 2-100 μm, more preferably 20-50 μm with lens heights of 1-50 μm, and more preferably still 5-25 μm. The periodicity, and therefore maximum base diameter, for the lenses 15 is preferably in the range 5-200 μm, more preferably 10-60 μm and even more preferably 20-40 μm. The f number for the lenses 15 is preferably in the range 0.25-16 and more preferably 0.5-2. They are typically formed by UV cast-cure replication or thermal embossing.

On the other (second) side of the carrier layer 16 is an image layer 17 (see FIG. 2) located at the focal distance of the lenses 15. The image layer 17 comprises a number of image strips 19 which are slices of a pair of images. In the illustrated embodiment of FIG. 2, each image is sliced into five image strips 19, which are individually labelled as Aa-Ae and Ba-Be, and which are respectively slices of the two images A, B. Image A is divided into image strips Aa-Ae and image B is divided into image strips Ba-Be. One image strip 19 from each image A, B is located under each cylindrical lens 15. Thus, in this embodiment, image strips Aa, Ba will be located under cylindrical lens 15a, image strips Ab, Bb will be located under cylindrical lens 15b and so on.

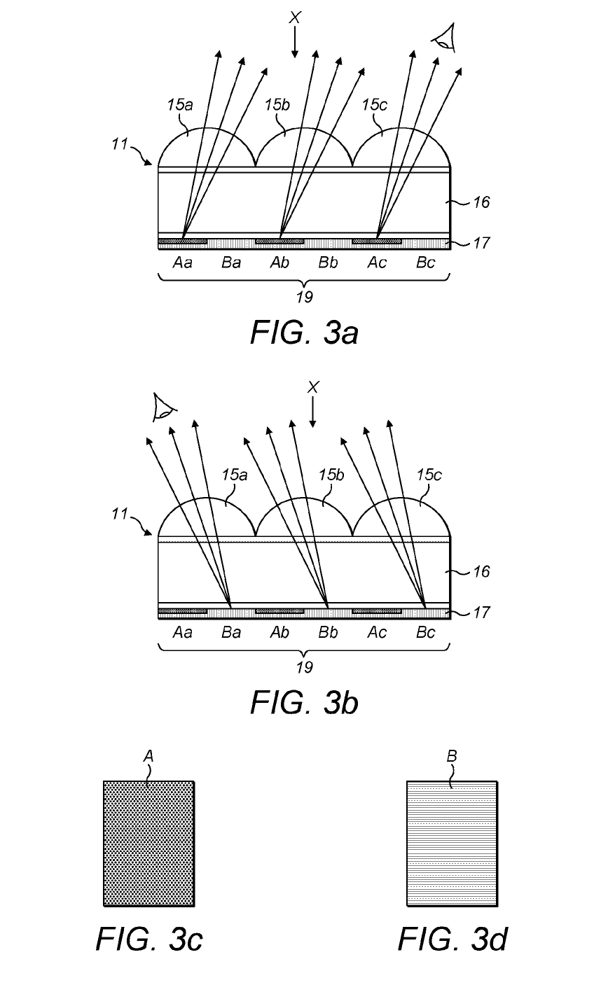

To illustrate the operation of the first security feature 11, a simplified structure is shown in FIGS. 3a and 3b, having only three lenses 15a, 15b, 15c and an image layer comprising image strips Aa, Ab, Ac, Ba, Bb, Bc, which respectively form the two images A, B. The image strips A,B are registered with each lens 15, so image strips Aa, Ba are registered with lens 15a; image strips Ab, Bb are registered with lens 15b; and image strips Ac, Bc are registered with lens 15c. When the first security feature 11 is viewed from the right (with the lenses 15 uppermost), the image strips Aa, Ab, Ac will be visible through each lens 15 and when the lenticular security feature 11 is viewed from the left, the image strips Ab, Bb, Cb will be visible. The resulting appearances of the first security feature 11 is shown in FIGS. 3c, 3d, where view A (the combination of image strip Aa, Ab, Ac) corresponds to viewing the first security feature 11 from the right as in FIG. 3c and view B (the combination of image strip Ba, Bb, Bc) corresponds to viewing the first security feature 11 from the left as in FIG. 3d.

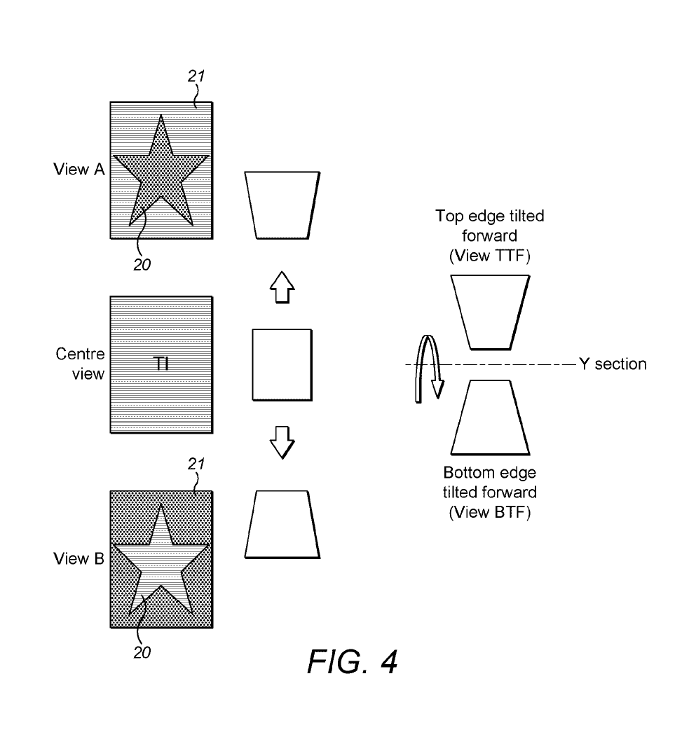

The images A, B may be any image and the example shown in FIG. 4 is a star shaped symbol 20 seen against a background 21. The colours of the symbol 20 and carrier layer 16 may be chosen so that in view A, the symbol 20 has a first colour (such as red) and the background 21 has a second colour (such as blue); while in view B, the colours are switched or reversed so that the symbol 20 has the second colour (blue) and the background 21 has the first colour (red). Alternatively (or additionally) the security device 10 may include a coloured layer 18 located on the image layer 17, on an opposite side to the carrier layer 16, to achieve this effect.

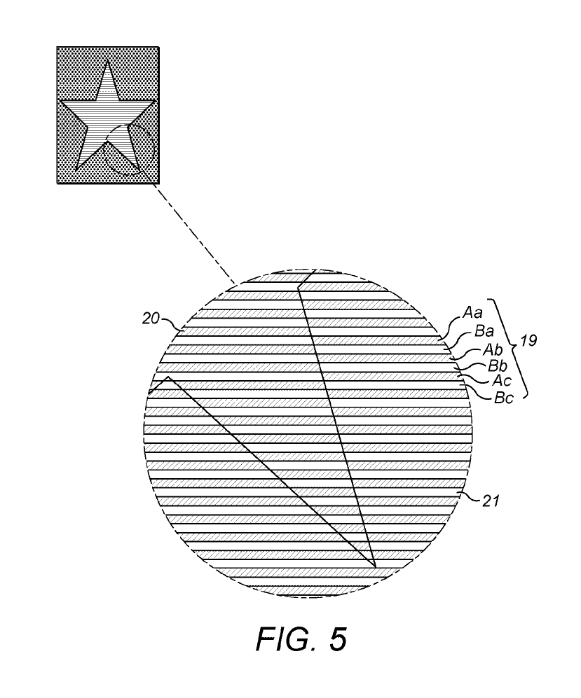

The manner in which this colour switch is achieved is shown in FIG. 5. In this Figure, part of the star shaped symbol 20 is shown along with part of the background 21. For simplicity, in this example, we will refer to the colours as “black” and “white” as shown in FIG. 5 although any pair of colours or regions of different reflectivity could be used. Considering first the image strip Aa, it will be seen that in the region of the background 21 the strip is black but in the region of the symbol 20 it changes to white. In contrast, the image strip Ba is white in the region of the background 21 and black in the region of the symbol 20. This lateral half-shift between the lines of the symbol 20 and background 21 means that the effect observed and shown in FIG. 4 is achieved. This lateral half shift is also illustrated in FIG. 2.

The image strips 19 in the image layer 17 may be printed by any suitable printing technique including, but not limited to, offset lithography, gravure, screen, flexographic printing onto the underside of the carrier layer 16. Thus, for example, some of the image strips 19 may first be printed in a first colour and then a continuous overprint of the second colour of other of the image strips 19. This second colour will be obscured where it is in alignment with the first colour. Other methods of providing the image elements in the strips are described in WO-A-2011/051668.

In the example just described, the image strips 19 are registered with the lenses 15. The exact registration of the image strips 19 and the lenses 15 enables the security device 10 to be configured such that it is known at what angle the different views are observed, i.e. in reference to FIG. 4 such that the black star is always observed when tilting forwards and the black background is always observed when tilting backwards. However, registration is not essential.

Thus, when the security device 10 is viewed in reflection from direction X, the first security feature 11 will cause at least two different images (which will be referred to subsequently as indicia) to be seen as the security device 10 is tilted. The images may differ from each other in terms of content, appearance, size and/or colour.

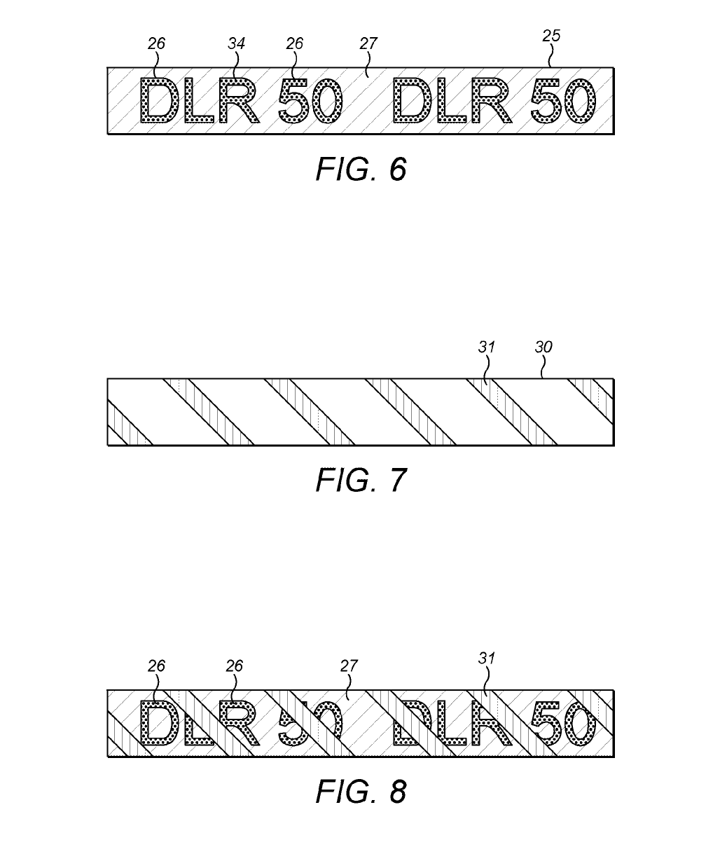

As shown in FIG. 1, a negative indicia security feature 13 is located adjacent the first security feature 11, on the underside of its lowermost layer which, in this embodiment, is the image layer 17 or the coloured layer 18 if that is included. The negative indicia security feature 13 comprises a partial opaque layer 25, in which there are a plurality of light transmissive regions 26 surrounded by opaque regions 27. The opaque regions will typically have an optical density of greater than 1, and more preferably greater than 2. The light transmissive regions 26 define so called “negative” indicia. In FIGS. 6 and 8 these negative indicia are the alphanumerics DLR 50. However the negative indicia may be any indicia, including alphanumerics, symbols, patterns, images and the like. In a preferred form, the partial opaque layer 25 may be self supporting or it may be formed by applying an opaque material to one or both sides of a transparent carrier substrate. The partial opaque layer 25 preferably comprises a partially metallised or partially demetallised layer, which is illustrated in FIG. 6. The partially metallised or partially demetallised layer has metal regions as the opaque regions 27 demetallised regions as the light transmissive regions 26, which form the negative indicia.

The negative indicia security feature 13 provides two benefits when used in conjunction with a lenticular type of security feature as proposed for the first security feature 11. Firstly it improves the brightness and contrast of the images displayed by the lenticular security feature as the metal regions 27 are visible in reflected light. This is particularly the case if diffractive relief structures are used to form the image strips 19 or where there are gaps between opaque regions within the image strips 19. Secondly it provides a security feature, which can be viewed in transmitted light, which the lenticular type of security feature does not provide. The negative indicia may be located in a separate region of the security device 10 to the first security feature(s) 11. However in an alternative embodiment they may be superimposed.

One way to produce a partially demetallised layer is to selectively demetallise a metallised film using a resist and etch technique, such as is described in U.S. Pat. No. 4,652,015. Other techniques are known for achieving similar effects; for example aluminium can be vacuum deposited through a mask, or aluminium can be selectively removed from a composite strip of a plastic carrier and aluminium using an excimer laser. The metal regions may be alternatively provided by printing a metal effect ink having a metallic appearance such as Metalstar® inks sold by Eckart on a transparent film. However, the opaque regions 27 do not have to be metal regions and can be provided by other opaque materials and inks.

As shown in FIG. 1, the second security feature 12 is located on the opposite side of the negative indicia security feature 13 to the first security feature 11. In this embodiment the second security feature 12 comprises a partial light scattering layer 30, which has regions 31 of a substance which causes scattering of incident light reflected thereby (i.e. diffuse reflection as opposed to specular reflection) and, if the material is transmissive, during transmission of light there through. The light scattering effect may be due to the nature of the substance or the form in which it is applied. The regions 31 form further indicia, for example a geometric pattern as shown in FIG. 7, a symbol, image, alphanumerics or any other type of indicia. These indicia may be related in content, form etc. to the indicia of the first security feature 11, the negative indicia or indicia or other content subsequently provided on the security substrate. Alternatively they could be unrelated.

The partial light scattering layer 30 may be formed from a magnetic material, which has the added benefit of providing a machine readable feature. Suitable magnetic materials are described in WO-A-03091952 and WO-A-03091953. Here a security element, comprising a transparent polymer carrier layer bearing indicia formed from a plurality of opaque and non-opaque regions, is coated with a substantially transparent magnetic layer containing a distribution of particles of a magnetic material of a size, and distributed in a concentration at which the magnetic layer remains substantially transparent. The magnetic material may be metallic iron, nickel or cobalt based materials (or alloys thereof) or any of the other magnetic materials described in WO-A-03091952, WO-A-03091953 and WO-A-2009/053673 including traditional iron oxides.

It has been found that certain magnetic materials are particularly suitable for magnetic light scattering materials, although this does not preclude the use of more conventional heavily coloured conventional magnetic materials, such as iron oxides (Fe₂O₃, Fe₃O₄), barium or strontium ferrites etc. These materials have particular magnetic properties which allow them to be distinguished from other magnetic materials. In particular, these materials have a lower coercivity than conventional iron oxide materials which means that they can be reversed in polarity by weaker bias magnetic fields during the detection process; whilst they are still magnetically hard so that they retain the induced magnetism which can then be detected when the article is in a region no longer affected by the bias magnetic field. Typically, these materials can support magnetic data in the same manner as conventional magnetic tape.

Suitable magnetic materials preferably have a coercivity in the range 50-150 Oe, and more preferably in the range 70-100 Oe. The upper limit of 150 Oe could be increased with higher biasing fields. A number of examples of suitable materials include iron, nickel, cobalt and alloys of these. In this context the term “alloy” includes materials such as nickel:cobalt, iron:aluminium:nickel:cobalt and the like. Flake nickel materials can be used; in addition iron flake materials are suitable. Typical nickel flakes have lateral dimensions in the range 5-50 microns and a thickness less than 2 microns. Typical iron flakes have lateral dimensions in the range 10-30 microns and a thickness less than 2 microns.

Metallic iron, nickel and cobalt based materials (and alloys thereof) have amongst the highest inherent magnetisations and so benefit from the requirement for least material in a product to ensure detectability. Iron is the best of the three with the highest magnetisation, but nickel has been shown to work well from other considerations. These materials are best used in their flake aspect to ensure that they are high remanence, hard magnetic materials that can support magnetic data if used in a magnetic tape format. This is because nickel and iron, for example, in flake form generally have high remanence. Flake and other shaped materials provide an anisotropy (Kₛₕₐₚₑ) defined as:

Kₛₕₐₚₑ=0.5 N_{d} Mₛ²/μ₀

### While

H_{c} α 2.Kₜₒₜₐₗ/Mₛ

Leading to a coercivity H_{c} which is proportional to Mₛ and N_{d} (See “Magnetism and Magnetic Materials”, J P Jakubovics, Uni Press Cambridge, end Ed.)

Where:
N_{d} is the shape factor
Mₛ is the saturation magnetism
μ₀ is the permeability of free space
H_{c} is the coercivity
Kₜₒₜₐₗ is the sum of all K components

It should be understood, however, that it may not be essential to take account of this shape effect for a material to exhibit low coercivity and high remanence. For example, the crystalline anisotropy of materials can also lead to a high remanence, hard magnetic low coercivity characteristic even if the material has a spherical shape, for example cobalt treated oxides.

A suitable magnetic ink composition can be obtained from Luminescence Inc. as 60681XM.

Conventional magnetic inks, with the common Fe₂O₃ or Fe₃O₄ pigments or similar, can, for example, be obtained from Luminescence Inc. as RD1790.

FIG. 8 shows the partial light scattering layer 30 superimposed on the partially demetallised layer 25. The indicia formed by the partially opaque and partial light scattering layers 25, 30 at least partially overlap, so there are some opaque regions 27 covered by light scattering regions 31 and some opaque regions 27 not covered by light scattering regions 31. Similarly there are some light transmissive regions 26 covered by light scattering regions 31 and some transmissive 26 not covered by light scattering regions 31.

The substance used to form the light scattering layer 30 is sufficiently transparent that the negative indicia are still visible in transmitted light.

A fluorescent layer 32 may be applied to the partial light scattering layer 30 and an adhesive layer 33 may be applied to the fluorescent layer 32.

When the second side of the security device 10 is viewed in transmission (from direction Y as shown in FIG. 1), the negative indicia security feature 13 has substantially the same appearance to that of the prior art Cleartext® security device, i.e. the negative indicia is highly visible. However, when the second side of the security device 10 is viewed in reflection from direction Y (i.e. the side of the substrate in which the second side of the security device is closest) the viewer is able to visualize the indicia provided by the partial light scattering layer 30. The present disclosure thus makes a benefit of the visualization of the light scattering effect of the partial light scattering layer 30 and combines this with all the known benefits of the negative indicia security feature 13.

The security device 10 is preferably partially or wholly embedded into a base substrate, such as paper or polymer, by any suitable method. However the security device 10 may also be applied to a surface of a base substrate. The resulting combination of a base substrate and security device 10 will be referred to herein as a security substrate, which can be used to manufacture a variety of security documents, such as banknotes, vouchers, fiscal stamps, authentication labels, passports, cheques, certificates, identity cards, or the like. In the case of a polymer substrate, for example a polymer banknote with a transparent polypropylene substrate, the substrate itself may also act as the carrier layer 16 of the security device.

A wholly embedded security device 10 is covered on both sides by the base substrate and a partially embedded device 10 is visible only partly at one or both surfaces of the security substrate. The latter form is commonly known as a windowed security thread and the security device 10 appears to weave in and out of the security substrate and is visible in windows in one or both surfaces of the security substrate. One method or producing security substrates with windowed security threads can be found in EP-A-0059056. EP-A-0860298 and WO-A-03095188 describe different approaches for the embedding of wider partially exposed device into a base substrate. Wide security devices 10, typically having a width of 2-6 mm, are particularly useful as the additional exposed surface area of the security device 10 allows for better use of optically variable devices, such as the lenticular security feature, which is an option for the first security feature 11 of the present disclosure.

Where the security element 10 is embedded (either wholly or partially) in certain base substrates, such as paper, the substrate, where it covers the security device 10, can act as a second light scattering layer. In such a configuration, light from the direction Y (see FIG. 1) passes through the base substrate where it is scattered to some extent. Where light is incident on the opaque regions 27 of the partial opaque layer 25 not covered by light scattering regions 31, it is reflected back into the base substrate and then undergoes further scattering before exiting the base substrate. In this case the light exiting the security substrate will be more diffuse than that incident on the security substrate due to the scattering effect of the base substrate. Furthermore, the reflected light will have lost some intensity when reflected by the opaque regions 27. This could equate, for example, to a 5% loss in intensity.

In contrast, where light is incident on the partial light scattering layer 30, it undergoes scattering when travelling both through the base substrate and the partial light scattering layer 30. Where the light scattering regions 31 overlie the opaque regions 27, this will result in a proportion of the light reflected from the interface between the opaque and light scattering regions 27,31 being scattered back towards the interface and undergoing multiple reflections at the interface resulting in a loss of intensity (for example 5%) each time this occurs before finally exiting the security substrate. The combination of intensity losses generated by the scattering of light from the security substrate and the partial light scattering layer 30 results in a significant reduction in the intensity of the reflected light from the regions of the security device 10 where the partial light scattering layer 30 is present, compared to the regions where the no light scattering material is present. This reduction in intensity results in the indicia formed by the partial light scattering layer 30 appearing relatively dark when viewed from the direction Y.

A separate further light scattering layer 32 (see FIG. 1) may also be included in the security device 10 if the base substrate in which it is embedded is transparent (either wholly or in the region where the light scattering security feature 12 is present) and/or has no light scattering properties. It is customary practice for security devices 10 having a width greater than approximately 2 mm to hide surfacing of the security device 10 from the embedded side by using a masking coat on the security device 10. A suitable material for such a masking coat, where the base substrate is paper, would be Coates 3188XSN or Coates Heliovyl White S90 353. A typical coat weight is suggested to be in the region of 2GSM. Such a masking coat has similar scattering properties to paper such that light reflected from the security device 10 appears diffuse and has a paper like appearance. The further scattering layer 32 results in the presence of the magnetic partial light scattering layer 14 being visualised as a dark image when viewed in reflection from direction Y. The further scattering layer 32 may include fluorescent pigments, which enhance the appearance of the light scattering security feature.

Unfortunately it has been found that the combination of some types of security features as used for the first and second security features 11, 12 together with the negative indicia security feature 13 in this manner can have an undesirable effect. This undesirable effect is that the negative indicia are not clearly visible in transmission due to interference from one or both of the first and second security feature 11, 12. For example, the optical density of a lenticular security feature as described above has been found to be in the region of 0.3 to 0.7 and more preferably 0.4-0.6, which is higher than the preferred optical density for the negative indicia of 0.20 to 0.30.

One way of increasing the clarity of the negative indicia when viewed in transmission is to increase the size of the light transmissive regions 26, to allow more light to be transmitted. However this in turn can also have a number of undesirable effects on certain types of security features which are combined, as described above. Firstly, it can result in the negative indicia being visible in reflected light (from either side of the security device). Secondly, it can interfere with the indicia of the light scattering security feature 12 when viewed from the direction Y. Thirdly, it can also result in elements of the first security 11 and the second security feature 12 being visible from the wrong side of the security device 10 through the negative indicia, i.e. the first security feature 11 becomes visible when viewed from the Y side and the second security feature 12 becomes visible when viewed from the X side. Again this can cause interference of the resulting security effects.

The solution to this problem is to both increase the minimum dimension of any clear region 26, to at least 200 μm and more preferably to at least 300 μm, and to provide a low optical density layer within the transmissive regions 26. The low optical density layer is semi-transparent in the visual spectral region and has substantially the same surface appearance as the opaque regions 27 when viewed in reflected light. Thus when the article security device 10 is viewed in reflected light, the transmissive regions 26 closely resemble the opaque regions 27 of the partial opaque layer 25. However, when the security device 10 is viewed in transmitted light, the transmissive regions 26 are readily discernable to the viewer. In effect, the low optical density layer is used to camouflage the transmissive regions in reflected light without interfering too much with the transmission of light, so that the transmissive regions 26 are still visually detectable in transmitted light.

The optical density of the low optical density layer is in the range 0.05-0.7, and preferably in the range 0.05-0.3, and more preferably in the range 0.05-0.2.

In one embodiment, the low optical density layer comprises a screen of elements 34 of an opaque material located within the transmissive regions 26. The screen can be regular or stochastic. Indeed, the term “screen” should be construed broadly to encompass many different shapes of screen elements 34. Non-linear screens may also be used. For example the screen could comprise a circular or sinusoidal array of dots or lines.

Preferably, the percentage of the transmissive regions 26 which are covered by the screen elements 34 is in the range 15-50%, and more preferably in the range 20-40%. The width of the lines or the diameter of the screen elements 34 is preferably in the range 50-200 μm but this will be dependent on the size of the transmissive regions 26; however the coverage of the screen pattern is more important. Although any opaque elements can be used for the screen elements 34, preferably they are specularly reflective and preferably they are formed from a vapour deposited metallic layer or a metallic like ink layer. One suitable configuration for the screen elements 34 is shown in FIG. 6.

In another embodiment, the low optical density layer comprises a continuous layer of a material which is located within the transmissive regions 26, which has a sufficiently low optical density to be semitransparent. Suitable materials include certain types of metal, printing inks with optically variable pigments therein, liquid crystal layers and diffraction structures with a semitransparent reflecting layer.

The preferred metal for both the opaque and low optical density layers is vacuum deposited aluminium, but other metals, for example nickel, gold, copper, and cobalt:nickel alloys, may be used for one or both layers. Instead of vacuum deposition other techniques such as electroplating may be used to deposit the layers.

Where the negative indicia security feature 13 is formed from a partially demetallised film, a semitransparent metal is preferred for the low optical density layer. One way of achieving this is to vacuum deposit the aluminium over the metal side of the partially demetallised film in which the transmissive regions 26 have already been formed. This forms a thin layer which is superposed on the opaque regions 27 and in the transmissive regions 26. The material of the low optical density layer must be selected to be sufficiently thick to provide a high level of reflectivity but, on the other hand, must be sufficiently thin to allow a visually detectable portion of light which is incident upon it to be transmitted through it.

Where appropriate, two or more thin transparent or translucent layers may be used within the structure in place of a single layer of low optical density, the combined optical density preferably being in the range as stated above.

The addition of this low optical density layer surprisingly leads to an improvement in the clarity of the negative indicia in transmission, whilst preventing the aforementioned see through problems in reflection. The low optical density layer achieves this improvement by balancing the reflection appearance and the transmission appearance of the security device 10.

To explain how the low optical density layer achieves this improvement, the problems arising from the combination of a lenticular security feature (as the first security feature 11), a light scattering security feature (as the second security feature 12) and a negative indicia security feature 13 formed from a partially demetallised film should first be considered. The lenticular security feature is most effective when the image elements 19 are printed as fine lines and preferably in a dark colour. However this can reduce the contrast between the image/colour switch. The lenticular security feature can be combined with a metal backing layer, as described in WO-A-2011/051668, which may be a full metal layer or a partially demetallised layer. However, the metal makes the reflective appearance of the lenticular security feature more specular, and thus lighting dependent. At some angles the contrast is better because of the metal, but if the contrast enhancement changes with angle, this can mask the image/colour switch. As a result, a coloured layer 18, which may provide a light scattering layer, may be used between the image elements 19 and the metal, which reduces the specular effect of the metal but does not eliminate it. If the metal is patterned (i.e. is partially demetallised), then there is still some effect in reflection at some angles which competes with the image of the lenticular security feature, especially as the demetallised area gets larger.

The problem is worse still if there is a darker coating visible through the demetallised layer, such as a dark magnetic ink, which may be used as the partial light scattering layer 30 of the second security feature 12. The same would apply to any other dark print that was on the back of the security substrate. This would be resolved if it were possible to use small demetallised indicia, but the dark colour of the image elements 19 reduces the transmission through the security device 10, which reduces the effect of the negative indicia security feature 13.

Additionally, the coloured layer 18 also reduces the transmission, although this may be less of an effect than the dark print of the image elements 19.

Whilst an increase in the size of the demetallised indicia would offset both of these issues, doing so can lead to interference between the security features from the opposing sides of the security device 10. For example, if the light scattering layer 30 was formed from a dark coloured material, this would become visible in reflection through the lenticular security feature where the light scattering regions 31 overlap with the demetallised indicia. To overcome this, the low optical density layer provides an amount of specular reflection from the demetallised areas, which reduces the contrast between the metal regions and the demetallised regions in reflection. Thus the appearance of the lenticular security feature dominates on the first side of the security device 10 and the appearance of light scattering layer 30 dominates on the second side of the security device 10.

A number of different types of security features may be used for the first and second security features 11,12. For example, as an alternative to the lenticular security feature, the first security feature 11 may be a colourshift feature, such as a thin film interference structure, a multilayer polymeric structure or a liquid crystal structure, which generate an angularly dependant coloured reflection. Examples of security devices utilising thin film interference structures are described in U.S. Pat. No. 4,186,943 and US-A-20050029800 and examples of security devices utilising multilayer polymeric structures are described in EP-A-1047549. These may be designed to show indicia when viewed in reflection or they may only show a colourshift. The security features selected for the first and second security features 11, 12 must also, when combined, at least partially transmit light, to enable the negative indicia security feature 13 to be visualised in transmission. At least one of the security features also has indicia which at least partially overlap with the indicia defined by the clear regions 26 of the negative indicia security feature 13.

When considering the security device 10 as a whole, the optical density in the light transmissive regions 26 is in the range of 0.4-1.2, and preferably in the range 0.6-1.0.

If another such form of colourshift feature is used as the first security feature 11, a similar problem occurs as described in relation to the lenticular security feature. As such features are also dark in transmission.

1. A security device comprising:
a partial opaque layer comprising a plurality of light transmissive regions surrounded by one or more opaque regions, the light transmissive regions defining negative indicia which are visible when the security device is viewed in transmission but not in reflection, the negative indicia having a minimum dimension of 200 μm;
a first security feature on one side of the partial opaque layer forming a first side of the security device; and
a second security feature on an opposing side of the partial opaque layer forming a second side of the security device;
wherein at least one of the first and second security features comprises indicia which are visible when the security device is viewed in reflection from one of the first or the second side of the security device and at least partially overlap with the negative indicia; and
a low optical density layer which is semitransparent in the visual spectral region is provided within the light transmissive regions, the low optical density layer comprising a substantially continuous layer of a semitransparent material or a screen formed of opaque screen elements.

2. The security device as claimed in claim 1, wherein the first security feature is an optically variable security feature.

3. The security device as claimed in claim 2, wherein the optically variable security feature is a colourshift feature.

4. The security device as claimed in claim 2, wherein the optically variable security feature comprises an array of focussing elements.

5. The security device as claimed in claim 2, wherein the optically variable security feature comprises a lenticular device, moiré interference device or moiré magnification device.

6. The security device as claimed in claim 2, wherein, when the first side of the security device is viewed in reflection, the indicia comprise at least two different images which are apparent at at least two respective angles of view.

7. The security device as claimed in claim 1, wherein the second security feature is a light scattering security feature defining the indicia which are visible when the second side of the security device is viewed in reflection.

8. The security device as claimed in claim 1, wherein the first and second security features each have indicia which are visible when the security device is viewed in reflection from the first and the second side of the security device respectively and which each at least partially overlap with the negative indicia.

9. The security device as claimed in claim 1, wherein the partial opaque layer is a partially demetallised film, the opaque regions being regions of metal.

10. The security device as claimed in claim 1, wherein the total optical density of the security device in the light transmissive regions is in the range 0.4-1.2.

11. The security device as claimed in claim 1, wherein the negative indicia having a minimum dimension of 300 μm.

12. The security device as claimed in claim 1, wherein the low optical density layer comprises a screen formed of opaque screen elements, which covers 15 to 50% of the area of the transmissive regions.

13. The security device as claimed in claim 12, wherein the screen elements are specularly reflective.

14. The security device as claimed in claim 13, wherein the screen elements are formed from metal or a metallic ink.

15. The security device as claimed in claim 1, wherein the low optical density layer has an optical density in the range of 0.05-0.7.

16. The security device as claimed in claim 1, wherein the semitransparent material is metal or metallic ink.

17. A security substrate comprising a base substrate and a security device as claimed in claim 1 at least partially embedded in the base substrate, or applied thereto.

18. A security document formed from the security substrate of claim 17, preferably comprising a banknote, voucher, fiscal stamp, authentication label, passport, cheque, certificate or identity card.

19. The security device as claimed in claim 10, wherein the range is 0.6-1.0.

20. The security device as claimed in claim 12, wherein the area of the transmissive regions is 20 to 40%.

21. The security device as claimed in claim 15, wherein the range is 0.05-0.3.

22. The security device as claimed in claim 15, wherein the range is 0.05-0.2.
